(19) United States
(12) Patent Application Publication
(10) Pub. No.: US 2012/0013851 A1
(43) Pub. Date: Jan. 19, 2012

(54) FRONT PROJECTION SCREEN WITH HIGH CONTRAST

(76) Inventors: YuFeng Liu, Woodbury, MN (US); David T. Yust, Woodbury, MN (US); Myron K. Jordan, Eagan, MN (US); Andrew J. Ouderkirk, Woodbury, MN (US)

(21) Appl. No.: 13/143,211

(22) PCT Filed: Jan. 6, 2010
(86) PCT No.: PCT/US2010/020176

§ 371 Date: Sep. 26, 2011

Related U.S. Application Data
(60) Provisional application No. 61/143,275, filed on Jan. 8, 2009.

(51) Int. Cl. G03B 21/60; G03B 21/28; G02B 5/02

(52) U.S. Cl. 353/29; 359/599; 359/454

(57) ABSTRACT

A light diffusing optical construction is disclosed. The optical construction includes an asymmetric optical diffuser that scatters light in a first direction with a first viewing angle A_{H} and in a second direction orthogonal to the first direction with a second viewing angle A_{V}. The ratio A_{H}/A_{V} is at least about 2. The optical construction also includes a substantially specular reflector that reflects light that is not scattered by the asymmetric optical diffuser. The substantially specular reflector has a first average reflectance Rₒ in the visible at a substantially zero incident angle and a second average reflectance R45 in the visible at a substantially 45 degree incident angle. The ratio Rₒ/R₄₅ is at least about 1.5. The optical construction also includes a light absorbing layer that absorbs light that is not reflected by the specular reflector.

### FIELD OF THE INVENTION

This invention generally relates to projection screens. The invention is particularly applicable to asymmetric front projection screens having high contrast and, in some cases, large horizontal viewing angles.

### BACKGROUND

Display devices generally display information to a viewer. The performance of a display is described in terms of various characteristics of the display. One such characteristic is the ability of the display to absorb ambient light originated from various sources of light such as a light bulb in a room or on a street or the sun. Generally, ambient light that is incident on a display and not absorbed by the display is superimposed on the displayed information resulting in reduced image contrast. The reduced contrast due to ambient light is generally referred to as washout. Washout is especially a concern in applications where the ambient light is very bright. For example, in outdoor applications, ambient light from the sun can significantly reduce the display contrast making it difficult for a viewer to discern the displayed information. A display, such as an instrument panel used in a motor vehicle, is particularly susceptible to washout from sun light. Typically, the display is placed in a housing to reduce ambient light access to the display. The housing is generally made black to further reduce washout by reducing the amount of light that is reflected by the housing.

Another characteristic of a display is the viewing angle. It is generally desirable that the displayed information be easily viewable over a predetermined range of viewing angles along the horizontal and vertical directions. As one display characteristic is improved, one or more other display characteristics often degrade. As a result, certain tradeoffs are made in a display device in order to best meet the performance criteria for a given display application. Thus, there remains a need for displays with improved overall performance while meeting the minimum performance criteria.

### SUMMARY OF THE INVENTION

Generally, the present invention relates to projection screens. The present invention also relates to projection systems that can display an image with high contrast.

In one embodiment, a light diffusing optical construction includes an asymmetric optical diffuser that scatters light in a first direction with a first viewing angle A_{H}, and in a second direction orthogonal to the first direction with a second viewing angle A_{V}, where the ratio A_{H}/A_{V} is at least about 2. The light diffusing optical construction also includes a substantially specular reflector that reflects light that is not scattered by the asymmetric optical diffuser. The substantially specular reflector has a first reflectance Rₒ at a substantially zero incident angle and a second reflectance R₄₅ at a substantially 45 degree incident angle, where the ratio Rₒ/R₄₅ is at least about 1.5. The light diffusing optical construction also includes a light absorbing layer that absorbs light that is not reflected by the substantially specular reflector.

In another embodiment, a projection system includes an image projecting light source that projects an image light generally along a first direction onto an image plane. The first direction makes an angle θ₁ with the horizontal direction. The projection system also includes an ambient light source that emits ambient light generally along a second direction that makes an angle θ₂ with the horizontal direction. The projection system also includes an asymmetric optical diffuser that is placed in the image plane and has a first viewing angle A_{H} along the horizontal direction and a second viewing angle A_{V} along the vertical direction. The ratio A_{H}/A_{V} is at least about 2. A_{V} is greater than θ₁ and smaller than θ₂. The projection system also includes a substantially specular reflector that reflects light that is not scattered by the asymmetric optical diffuser. The substantially specular reflector has a first reflectance R₁ at the incident angle of about θ₁ and a second reflectance R₂ at the incident angle of about 0₂, where R₁/R₂ is at least about 1.5.

### BRIEF DESCRIPTION OF DRAWINGS

The invention may be more completely understood and appreciated in consideration of the following detailed description of various embodiments of the invention in connection with the accompanying drawings, in which:

FIG. 1 is a schematic side-view of a projection system;

FIG. 2 is schematic plots of horizontal and vertical gain curves for a projection screen;

FIG. 3 is a schematic side-view of a projection system;

FIG. 4 is a schematic side-view of an optical diffuser;

FIG. 5 is plots of measured horizontal and vertical gain curves; and

FIG. 6 is a schematic top-view of a structured surface.

In the specification, a same reference numeral used in multiple figures refers to the same or similar elements having the same or similar properties and functionalities.

### DETAILED DESCRIPTION

The present invention is generally related to projection screens. The disclosures are particularly related to asymmetric projection screens that redirect a desired light, such as light from an image projector, to a viewer, and redirect an undesired light, such as light from an ambient light source, away from the viewer. The disclosures are particularly suited for display devices used outdoors or in well-lit environments.

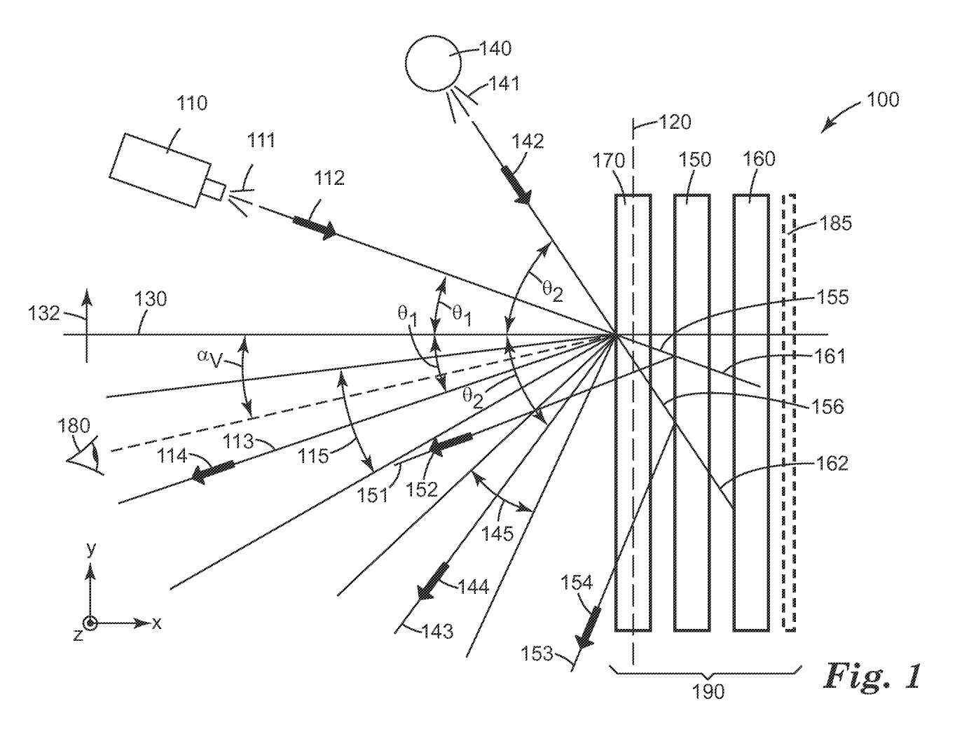

FIG. 1 is a schematic side-view of a projection system 100 that generally defines three orthogonal axes x, y and z. Projection system 100 includes an image projecting light source 110, an ambient light source 140, and a light diffusing optical construction 190 that includes an asymmetric optical diffuser 170, a substantially specular reflector 150, and a light absorbing layer 160.

Image projecting light source 110 projects an image light 111 generally along a first direction 112 onto an image plane 120. First direction 112 makes an angle θ₁ with a horizontal direction 130 along the x-axis. In some cases, angle θ₁ is substantially equal to zero. In such cases, the angle θ₁ is less than about 20 degrees, or less than about 15 degrees, or less than about 10 degrees, or less than about 5 degrees, or less than about 3 degrees.

Ambient light source 140 emits ambient light 141 generally along a second direction 142 that makes an angle θ₂ with horizontal direction 130. In some cases, the angle θ₂ is substantially larger than the angle θ₁. In such cases, the angle θ₂ is greater than the angle θ₁ by at least about 20 degrees, or at least about 30 degrees, or at least about 40 degrees, or at least about 50 degrees, or at least about 60 degrees, or at least about 70 degrees. In some cases, the angle θ₂ is greater than about 40 degrees, or greater than about 50 degrees, or greater than about 60 degrees, or greater than about 70 degrees.

Asymmetric optical diffuser 170 scatters an incident light differently along different directions, such as along horizontal direction 130 parallel to the x-direction and along a vertical direction 132 that is parallel to the y-direction. FIG. 2 is schematic plots of respective horizontal and vertical gain curves 210 and 220 of asymmetric optical diffuser 170 along the mutually orthogonal horizontal and vertical directions. Asymmetric optical diffuser 170 has a maximum gain gₒ that corresponds to the on-axis or zero viewing angle and a half-maximum gain g₁=g₀/2 that defines a horizontal viewing angle A_{H} that is equal to A_{H1}-A_{H2} and a vertical viewing angle A_{V} that is equal to A_{V1}-A_{V2}. A_{H1} and A_{H2} may be referred to as the positive and negative horizontal viewing angle, respectively, and A_{V1} and A_{V2} may be referred to as the positive and negative vertical viewing angles, respectively. In the exemplary gain plots of FIG. 2, each of gain curves 210 and 220 is symmetric about the on-axis viewing direction. In general, gain curves 210 and 220 may or may not be symmetric about the on-axis viewing direction. For example, in some cases, the positive viewing angle A_{H1} corresponding to the half-brightness viewing angle for positive viewing angles may be different than the negative viewing angle A_{H2} corresponding to the half-brightness viewing angle for negative viewing angles.

Referring back to FIG. 1, optical diffuser 170 is an asymmetric diffuser meaning that the horizontal viewing angle A_{H} is different than the vertical viewing angle A_{V}. In some cases, asymmetric optical diffuser 170 scatters light in a first direction, such as the horizontal direction, with a first viewing angle A_{H}, and in a second direction orthogonal to the first direction, such as the vertical direction, with a second viewing angle A_{V}. In some cases, the ratio A_{H}/A_{V} is at least about 2, or at least about 2.2, or at least about 2.5, or at least about 2.7, or at least about 3, or at least about 3.2, or at least about 3.5, or at least about 3.7, or at least about 4. In some cases, the horizontal viewing angle A_{H} is greater than the vertical viewing angle A_{V} by at least about 40 degrees, or at least about 50 degrees, or at least about 60 degrees, or at least about 70 degrees, or at least about 80 degrees, or at least about 90 degrees. Asymmetric optical diffuser 170 is placed in image plane 120 along vertical direction 132. Asymmetric diffuser 170 receives image light 111 and scatters the image light to form a scattered image light 113 propagating generally along a second direction 114. In some cases, directions 112 and 114 are symmetric about the x-axis. In such cases, second direction 114 makes an angle θ₁ with horizontal direction 130. In some cases, scattered image light 113 has a vertical image light cone 115 that includes or covers a desired viewing position 180 that makes an angle ay with horizontal direction 130.

Asymmetric diffuser 170 receives ambient light 141 and scatters the ambient light to form a scattered ambient light 143 propagating generally along a fourth direction 144. In some cases, directions 142 and 144 are symmetric about horizontal direction 130. In such cases, fourth direction 144 makes an angle θ₂ with horizontal direction 130. In some cases, scattered ambient light 143 has a vertical ambient light cone 145 that does not include or does not cover desired viewing position 180.

In some cases, viewing position 180 is included in, or is positioned within, vertical image light cone 115, but not vertical ambient light cone 145. In such cases, a viewer in viewing position 180 can see an image with high contrast as such an image does not include, or includes very little, ambient light originating from ambient light source 140. In some cases, the vertical viewing angle of asymmetric diffuser 170 is sufficiently large so than vertical image light cone 115 includes or covers viewing position 180, and sufficiently small so that vertical ambient light cone 145 does not include viewing position 180.

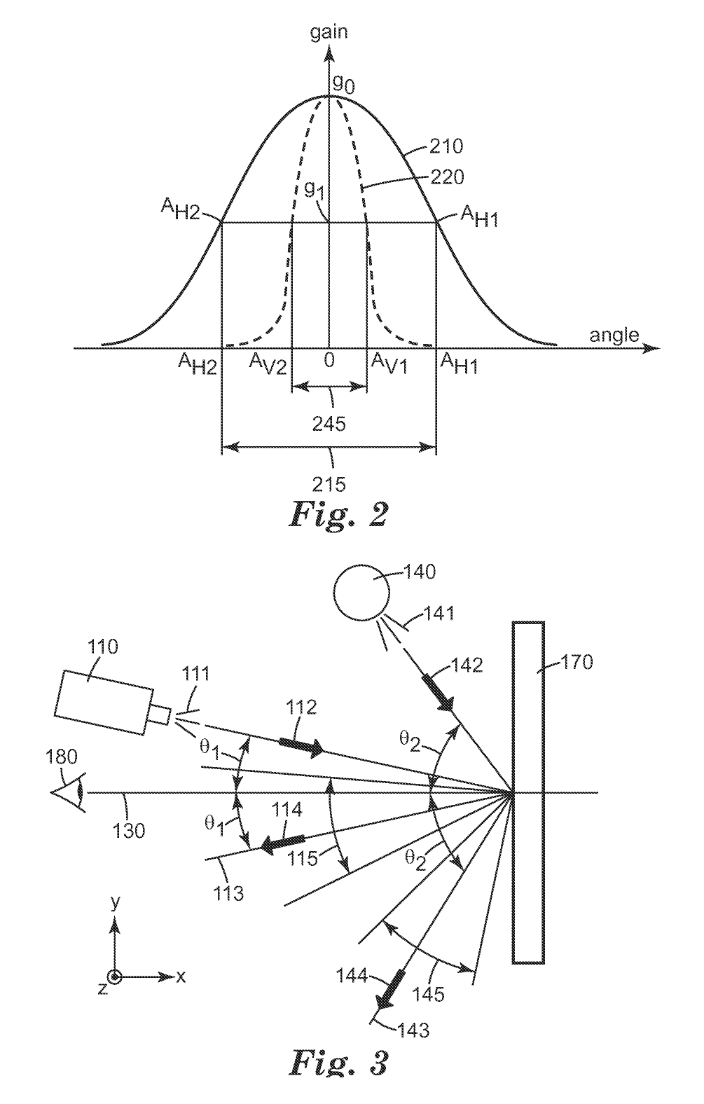

In some cases, such as when the angle α_{V} is substantially equal to zero as shown schematically in FIG. 3, image light that is scattered by asymmetric diffuser 170 reaches viewing position 180 and ambient light that is scattered by the diffuser propagates away from the viewing position. In such cases, the half vertical viewing angle (A_{V}/2) of diffuser 170 is greater than θ₁ and smaller than θ₂. In such cases, a viewer in viewing position 180 observes a displayed image with enhanced contrast.

Reflector 150 reflects image light 155 that is not scattered by optical diffuser 170. In some cases, reflector 150 is substantially a specular reflector. In such cases, a substantial fraction of the total light reflected by reflector 150 is reflected specularly and only a small fraction of the total reflected light is reflected diffusely. For example, in such cases, the ratio of the specular reflectance to the total reflectance of reflector 150 at a visible wavelength is at least about 0.7, or at least about 0.75, or at least about 0.8, or at least about 0.85, or at least about 0.9, or at least about 0.95, where the visible wavelength can be any wavelength in the visible range of the electromagnetic spectrum. In some cases, the visible range is from about 400 nm to about 690 nm, or from about 410 nm to about 680 nm, or from about 420 nm to about 670 nm.

Reflector 150 specularly reflects image light 155 as reflected image light 151 along a fifth direction 152 that makes an angle θ₁ with the horizontal direction. Reflector 150 reflects ambient light 156 that is not scattered by optical diffuser 170. Reflector 150 specularly reflects ambient light 156 as reflected ambient light 153 along a sixth direction 154 that makes an angle θ₂ with the horizontal direction. In some cases, the locations of viewing position 180, image projecting light source 110, and ambient light source 140 are such that a viewer in viewing position 180 receives and views reflected image light 151 but not reflected ambient light 153. In such cases, specular reflector 150 reflects image light 155 that is not scattered by asymmetric optical diffuser 170 towards the viewing position and reflects ambient light 156 that is not scattered by asymmetric optical diffuser 170 away from the viewing position. In such cases, a viewer positioned in viewing position 180 can observe an image with increased contrast.

In some cases, the reflectance of specular reflector 150 does not change, or changes very little, with increasing incident angle. In such cases, specular reflector 150 has a first average reflectance R₁ in the visible at an incident angle of about θ₁ and a second average reflectance R₂ in the visible at an incident angle of about θ₂, where the difference between R₁ and R₂ is no more than about 10%, or no more than about 5%, or no more than about 2%. In some cases, the angle θ₁ is about zero and the angle θ₂ is about 45 degrees.

In some cases, the reflectance of specular reflector 150 changes, such as decreases, with increasing incident angle. In some cases, such as when angle θ₁ is substantially less than angle θ₂, a reflector 150 that has decreasing reflectance with increasing incident angle can increase the contrast of an image that is displayed to a viewing position, such as viewing position 180. In some cases, specular reflector 150 has a first average reflectance R₁ in the visible at an incident angle of about θ₁ and a second average reflectance R₂ in the visible at an incident angle of about θ₂, where the ratio R₁/R₂ is at least about 1.2, or at least about 1.4, or at least about 1.5, or at least about 1.6, or at least about 1.8, or at least about 2, or at least about 2.5, or at least about 3. In some cases, the angle θ₁ is about zero and the angle θ₂ is about 45 degrees.

In some cases, specular reflector 150 can have a substantially flat reflectance spectrum in a region, such as the visible region, of the electromagnetic spectrum. For example, in such cases, the reflectance of the specular reflector changes by no more than 20%, or by no more than 15%, or by no more than 10%, or by no more than 5% in the visible. In some cases, the ratio of the reflectance of reflector 150 at a blue wavelength, such as at 440 nm, and the reflectance at a red wavelength, such as at 620 nm, is in a range from about 0.8 to about 1.2, or in a range from about 0.9 to about 1.1.

In general, specular reflector 150 can be any specular reflector that may be desirable and/or practical in an application. For example, specular reflector 150 can be an aluminized film or a multi-layer polymeric reflective film, such as a reflective polarizing film or a Vikuiti ESR film available from 3M Company, St. Paul, Minn.

Light absorbing layer 160 can increase the contrast of a displayed image by absorbing image light 161 and ambient light 162 that are not reflected by specular reflector 150. Light absorbing layer 160 can include any light absorbing material that may be desirable and/or practical in an application. For example, layer 160 can include carbon black, light absorptive dyes such as black dyes or other dark dyes, light absorptive pigments or other dark pigments, or opaque particles, dispersed in a binder material. Suitable binders include thermoplastics, radiation curable or thermoset acrylates, epoxies, silicone-based materials, or other suitable binder materials. In some cases, the optical absorption coefficient of light absorbing layer 160 in the visible, is at least about 0.1 inverse microns, or at least about 0.2 inverse microns, or at least about 0.4 inverse microns, or at least about 0.6 inverse microns.

In some cases, optical construction 190 includes an optional substrate 185. In some cases, substrate 185 can primarily provide support for the other components in the optical construction. In some cases, substrate 185 can provide one or more additional optical functions. For example, substrate 185 can be or include an optical diffuser, a broadband light absorber, an absorbing polarizer, a reflective polarizer, or any other film with a function that may be desirable in an application. Substrate 185 can be any material that may be suitable and/or practical in an application, such as polyethylene terapthalate (PET), polyvinyl chloride (PVC), polycarbonates, acrylics, aluminum sheet, and glass, and composites thereof.

In general, optical construction 190 can be employed in any application where it may be desirable to scatter light asymmetrically. For example, optical construction 190 can be, or be part of, a front projection screen.

Image projecting light source 110 includes an image forming device and projects an image formed by the device onto display or image plane 120. Output light 111 of projector 110 can have any polarization that may be desirable in an application. For example, in some cases, output light 111 is substantially unpolarized. In such cases, the ratio of the intensity of output light 111 having a first polarization state and the intensity of output light having a second polarization state normal to the first polarization state is in a range from about 0.8 to about 1.2, or from about 0.85 to about 1.15, or from about 0.9 to about 1.1, or from about 0.95 to about 1.05. In some cases, output light 111 is substantially polarized, for example, along a first direction. In such cases, the ratio of the intensity of output light 111 having a first polarization state to the intensity of output light having an orthogonal polarization state is at least about 100, or at least about 500, or at least about 1000. In some cases, output light 110 includes a mixture of polarization states.

For example, in some cases, output light 110 can include red, green and blue lights where the blue and red lights have one polarization state and the green light has an orthogonal polarization state.

In general, image projecting light source 110 can include any image forming device. For example, the image forming device can be a reflective display, a transmissive display, or an emissive display, or a combination of different display types, such as a transflective display. For example, in some cases, a reflective image forming device can include an LCD or a digital micro-mirror array display, such as a Digital Light Processor (DLP) display from Texas Instruments, Inc.

In general, asymmetric optical diffuser 170 can be any asymmetric diffuser that may be desirable and/or practical in an application. For example, asymmetric diffuser 170 can be a bulk diffuser and/or a surface diffuser. Bulk diffusion can be achieved by, for example, incorporating or dispersing small particles of a guest material in a host material where the guest and host materials have different indices of refraction. Surface diffusion can be achieved by, for example, making the surface of the diffuser matte. In some cases, diffuser 170 is a bulk diffuser and the difference between the indices of refraction of the guest and host materials is at least about 0.01, or at least about 0.02, or at least about 0.03, or at least about 0.04.

In some cases, asymmetric optical diffuser 170 can be substantially polarization-insensitive. In such cases, the gain curves, such as horizontal gain curves 210, of the asymmetric optical diffuser for two mutually orthogonal polarized incident lights along a given direction, such as the horizontal direction, are substantially the same. For example, in such cases, horizontal gain curves 210 for two mutually orthogonal polarized incident lights along the horizontal direction differ by no more than about 15%, or by no more than about 10%, or by no more than about 5%. As another example, vertical gain curves 220 for two mutually orthogonal polarized incident lights along the vertical direction differ by no more than about 15%, or by no more than about 10%, or by no more than about 5%.

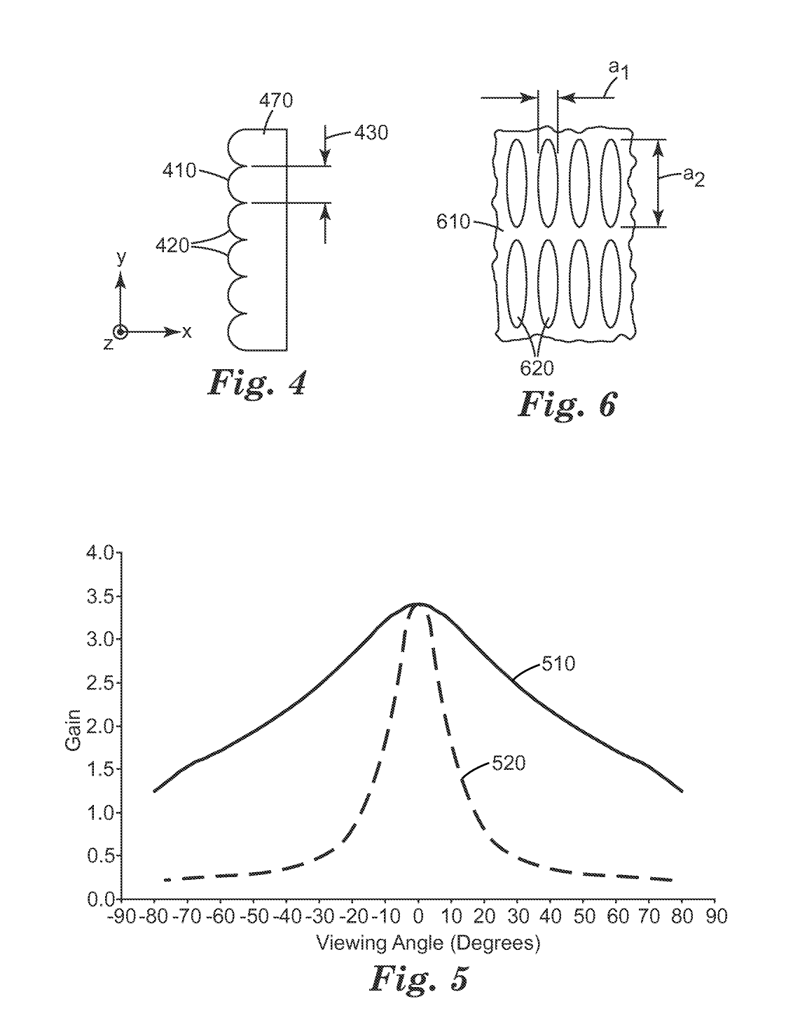

In some cases, asymmetric optical diffuser 170 can include a structured surface or layer. The structured layer can include structures having any shape that may be desirable in an application. Exemplary shapes includes planar, concave, convex, aspheric, Fresnel, ellipsoidal, fibril, diffractive, and faceted shapes. For example, FIG. 4 is a schematic side-view of an asymmetric optical diffuser 470 that includes a structured surface 410 that includes a plurality of optical lenses, such as microlenses, 420 with a pitch 430. In some cases, at least some of the optical lenses can be anamorphic for, for example, altering the aspect ratio of an image projected by image projecting light source 110. In some cases, an anamorphic lens can be or include an elongated, such a cylindrical, lens. In some cases, asymmetric optical diffuser 170 can include an array of elongated optical lenses, such as an array of cylindrical lenses, with a random pitch 430. FIG. 6 is a schematic top-view of a structured surface 610, similar to structured surface 410, that includes a plurality of lenslets 620. Each lenslet has a width a₁, a length a₂, and an aspect ratio a₂/a₁. In some cases, the aspect ratio is in a range from about 1.5 to about 200, or from about 2 to about 100, or from about 2 to about 50, or from about 2 to about 25.

In some cases, asymmetric optical diffuser 170 is a bulk diffuser and includes a plurality of elongated structures or particles of a first material within a second material where the two materials have different indices of refraction. In some cases, the elongated particles are generally oriented along the same direction, such as along vertical direction 132. In some cases, the length of an elongated particle is in a range from about 50 nm to about 100 microns, or from about 100 nm to about 50 microns, or from about 200 nm to about 10 microns. In some cases, the aspect ratio of an elongated particle is in a range from about 5:1 to about 1000:1, or from about 10:1 to about 200:1, or from about 20:1 to about 50:1.

In some cases, optical construction 190 is an integrated construction meaning that the individual components in the construction are attached to one another by, for example, one or more adhesive layers.

Some of the advantages of the disclosed systems and constructions are further illustrated by the following examples. The particular materials, amounts and dimensions recited in this example, as well as other conditions and details, should not be construed to unduly limit the present invention.

### Example 1

An asymmetric optical diffuser similar to diffuser 170 was fabricated. Pallets of polypropelene (PP) (PP1024 available from Exxon Chemicals, Houston, Tex.) and oven dried (at 176° F. for 10 hours) polystyrene (PS) (Styron 685D available from Dow Chemical, Midland, Mich.) were mixed at a weight ratio of about 60/40 (PP/PS) and added to an extruder. The mixture was melt extruded at an extrusion temperature of about 460° F., an extrusion rate of about 300 lbs/hour, and a line speed of about 50 feet per minute. The extruded film thickness was about 100 microns. During extrusion, the melted PS minor phase was stretched into elongated particles, oriented generally along the web or extrusion direction. The elongated particles were rod-shaped with an average diameter of about 1000 nanometers and an average aspect ratio of about 100. The index of refraction of the elongated PS particles was 1.58. The index of refraction of the PP host was 1.50.

Next, the extruded film was laminated to an enhanced specular reflector film (ESR) available from 3M Company, St. Paul, Minn. The ESR film had a reflectance of about 99% in the wavelength range from about 400 nm to about 1000 nm at normal incidence. The reflectance of the ESR remained at about 99% at 45 degrees incident angle. The lamination was done using optically clear adhesive OCA-8171 available from 3M Company, St. Paul, Minn. The reflectance of the resulting film in the visible was about 90% at zero incident angle and about 80% at an incident angle of about 45 degrees. Next, using the same clear adhesive, the resulting laminate was laminated to light absorbing black film (ScotchCal Graphic Film 7725 available from 3M Company, St. Paul, Minn.). The resulting front projection screen had the following attributes: an on-axis gain of about 3.5; a horizontal viewing angle A_{H} of about 120 degrees, and a vertical viewing angle A_{V} of 25 degrees.

The reflectance RR_{θ} of the screen was measured normal to the screen for light incident on the screen at several different incident angles θ. The ratio RR₄₅/RRₒ (horizontal incident angles of 45 and zero degrees) was about 0.66. A similar ratio in the case of a lambertian diffuser was about 0.82, indicating that compared to the lambertian diffuser, the screen had an improved ambient light rejection of about 19%. The screen had an improved ambient light rejection of about 27% for a horizontal incident angle of 60 degrees. The screen had an improved ambient light rejection of about 72% for a vertical incident angle of 45 degrees. The RR_{θ} measurements were carried out in the presence of a 500 lux ambient light. The average difference in the reflectance of the screen between horizontally and vertically polarized incident lights was less than about 5%.

FIG. 5 shows measured horizontal gain curve 510 and vertical gain curve 520.

### Example 2

An optical construction similar to the construction of Example 1 was fabricated except that the reflector film was a narrow-band specular reflector film (c-ESR) available from 3M Company, St. Paul, Minn. The c-ESR film had a reflectance of about 99% in the wavelength range from about 400 nm to about 700 nm at normal incidence. The ratio of the average reflectance of the c-ESR film in the visible at zero incident angle to 45 degrees incident angle was about 1.7. The resulting front projection screen had the following attributes: an on-axis gain of about 3.5; a horizontal viewing angle A_{H} of about 120 degrees, and a vertical viewing angle A_{V} of about 25 degrees.

The ratio RR₄₅/RRₒ (horizontal incident angles of 45 and zero degrees) was about 0.62. A similar ratio in the case of a lambertian diffuser was about 0.82, indicating that compared to the lambertian diffuser, the screen had an improved ambient light rejection of about 24%. The screen had an improved ambient light rejection of about 31% for a horizontal incident angle of 60 degrees. The screen had an improved ambient light rejection of about 79% for a vertical incident angle of 45 degrees and about 84% for a vertical incident angle of about 60 degrees. The RR_{θ} measurements were carried out in the presence of a 500 lux ambient light. The average difference in the reflectance of the screen between horizontally and vertically polarized incident lights was less than about 5%.

As used herein, terms such as “vertical”, “horizontal”, “above”, “below”, “left”, “right”, “upper” and “lower”, “front” and “back”, “clockwise” and “counter clockwise” and other similar terms, refer to relative positions as shown in the figures. In general, a physical embodiment can have a different orientation, and in that case, the terms are intended to refer to relative positions modified to the actual orientation of the device. For example, even if the construction in FIG. 1 is rotated by 90 degrees as compared to the orientation in the figure, arrow direction 130 is still considered to be along the “horizontal” direction.

All patents, patent applications, and other publications cited above are incorporated by reference into this document as if reproduced in full. While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the spirit and scope of the invention as defined by the appended claims.

1. A light diffusing optical construction comprising:
an asymmetric optical diffuser scattering light in a first direction with a first viewing angle A_{H}, and in a second direction orthogonal to the first direction with a second viewing angle A_{V}, A_{H}/A_{V} being at least about 2;
a substantially specular reflector reflecting light that is not scattered by the asymmetric optical diffuser and having a first average reflectance Rₒ in the visible at a substantially zero incident angle and a second average reflectance R₄₅ in the visible at a substantially 45 degree incident angle, Rₒ/R₄₅ being at least about 1.5; and
a light absorbing layer absorbing light that is not reflected by the specular reflector.

2-7. (canceled)

8. The light diffusing optical construction of claim 1, wherein the asymmetric optical diffuser comprises a plurality of elongated structures within a first material, the elongated structures being generally oriented along the second direction.

9. (canceled)

10. The front projection screen of claim 1, wherein gain curves of the asymmetric optical diffuser for two mutually orthogonal polarized incident lights differ by no more than about 10%.

11-12. (canceled)

13. The light diffusing optical construction of claim 1, wherein a ratio of a specular reflectance to a total reflectance of the substantially specular reflector at a visible wavelength is at least about 0.8.

14-17. (canceled)

18. The light diffusing optical construction of claim 1, wherein a ratio of a reflectance at a blue wavelength and a reflectance at a red wavelength of the substantially specular reflector is in a range from about 0.8 to about 1.2.

19. (canceled)

20. The light diffusing optical construction of claim 1, wherein the asymmetric optical diffuser comprises a plurality of optical lenses.

21-23. (canceled)

24. A projection system comprising:
an image projecting light source projecting an image light generally along a first direction onto an image plane, the first direction making an angle θ₁ with a horizontal direction;
an ambient light source emitting ambient light generally along a second direction that makes an angle θ₂ with the horizontal direction;
an asymmetric optical diffuser placed in the image plane and having a first viewing angle A_{H} along the horizontal direction and a second viewing angle A_{V} along a vertical direction orthogonal to the horizontal direction, A_{H}/A_{V} being at least about 2; A_{V}/2 being greater than θ₁ and smaller than θ₂; and
a substantially specular reflector reflecting light that is not scattered by the asymmetric optical diffuser and having a first average reflectance R₁ in the visible at an incident angle of about θ₁ and a second average reflectance R₂ in the visible at an incident angle of about θ₂, R₁/R₂ being at least about 1.5.
